(19) United States
(12) Patent Application Publication
(10) Pub. No.: US 2026/0000091 A1
(43) Pub. Date: Jan. 1, 2026

(54) Slush Machine

(71) Applicant: Cixi City Spring Electric Appliance Co., Ltd., Cixi City (CN)

(72) Inventor: Mengbo Yang, Cixi City (CN)

(73) Assignee: Cixi City Spring Electric Appliance Co., Ltd., Cixi City, ZJ (CN)

(21) Appl. No.: 19/301,838

(22) Filed: Aug. 15, 2025

(30) Foreign Application Priority Data
Sep. 26, 2024 (CN) 202411350612.3
Oct. 28, 2024 (CN) 202422602167.7
Oct. 28, 2024 (CN) 202422602171.3
Oct. 31, 2024 (CN) 202422645972.8

(51) Int. Cl. A23G 9/22; A23G 9/04

(52) U.S. Cl. CPC A23G 9/22; A23G 9/045

(57) ABSTRACT

The present invention relates to a slush machine, comprising a main body and a refrigerator cover detachably fixed to the main body, wherein a refrigeration system is arranged in the main body, wherein an evaporator of the refrigeration system is connected to receive refrigeration, and a rotating scraper structure scrapes off condensation on the outer surface of the evaporator; the main body also comprises a discharging structure; the evaporator comprises an outer barrel, wherein a refrigeration medium is filled in the interior of the outer barrel, and liquid is condensed on the outer surface of the outer barrel and then scraped off by the rotating scraper structure; the inner barrel is also comprised of a cylindrical shell having openings at both ends and being coaxial with the outer barrel, so that a closed refrigeration chamber is formed between the inner barrel and the outer barrel.

### TECHNICAL FIELD

The present invention relates to the technical field of refrigeration devices, in particular to a slush machine.

### BACKGROUND

At present, the evaporators of water-ice machines, ice cream machines and slush machines are most commonly evaporators with spiral copper tubes. In such evaporators, a spiral tube is placed in an inner or outer cylinder 100, and the refrigeration medium flows through the spiral tube. After the spiral tube wall contacts the inner or outer cylinder 100 for heat transfer, it can be transferred to a cooled liquid. Dependent on the spiral tube and the wall thickness of the inner and outer cylinders 100, the path of heat transfer is not simple and direct, so the refrigeration effect is not ideal. In addition, the spiral tube itself has a certain gap, which means that the spiral tube cannot fully contact the inner or outer cylinder 100, resulting in poor heat transfer efficiency. After extended use, the spiral tube may also separate from the inner or outer cylinder 100 due to factors such as its own tension, resulting in poor refrigeration or even no refrigeration. In addition, the polyurethane foam filler used as an insulation layer material can easily squeeze into the spiral tube when foaming and expanding, so that the spiral tube becomes separated from the inner or outer cylinder 100, which also leads to poor refrigeration or no refrigeration. Therefore, evaporators with spirally wound copper tubes have low refrigeration efficiency, poor working reliability, and low heat transfer capacity. Wound spiral tubes are also dense, resulting in high production costs.

Moreover, in the prior art, product discharge structures are set at the front of the ice making refrigerator, resulting in some slush remaining in the ice making refrigerator for a long time prior to discharge, affecting the freshness of the ice product. In addition, the ice discharge structure is relatively fragile and has low strength.

### SUMMARY

In order to solve the above problems existing in the prior art, the present invention provides a slush machine.

The above problems are solved by the following technical solutions:

Disclosed is a slush machine, comprising a main body and a refrigerator cover detachably fixed on the main body, wherein a refrigeration system is arranged in the main body, wherein the evaporator of the refrigeration system is connected to receive refrigeration, and a rotating scraper structure scrapes off the condensate on the outer surface of the evaporator. The main body also comprises a discharging structure. The evaporator comprises an outer barrel, wherein the interior of the outer barrel is filled with a refrigeration medium, and the liquid is condensed on the outer surface of the outer barrel and then scraped off by the rotating scraper structure. The evaporator also has an inner barrel, which is a cylindrical shell with openings at both ends and coaxial with the outer barrel, wherein the first end is connected to the end of the outer barrel, and the second end is provided with a folded edge outwardly, so that a closed refrigeration chamber is formed between the inner barrel and the outer barrel.

The folded edge of the inner barrel is provided with a notch, and a liquid inlet groove connected to the notch is provided in the refrigeration chamber. The refrigeration medium enters the refrigeration chamber through the liquid inlet groove, and the liquid inlet pipe extends into the liquid inlet groove through the notch.

The above technical solution is further configured as follows: a liquid guide member is provided in the refrigeration chamber, wherein the liquid inlet groove is located on the liquid guide member. At least one end of the liquid inlet groove is open and connected to the gap.

The evaporator is further configured as follows: the liquid guide member includes a liquid guide bottom connected to the outer wall of the inner barrel and a liquid guide wall is formed on both sides of the liquid guide bottom, wherein the liquid inlet groove is located between the liquid guide bottom and the liquid guide wall;

The end of the liquid guide wall is folded outward and provided with a flange.

The evaporator further comprises a plurality of liquid outlet holes are distributed on the liquid guide member and connected to the liquid inlet groove.

The liquid outlet holes are arranged on the liquid guide wall.

The discharge structure of the refrigeration unit is a horizontal cylinder, the outer end of the cylinder is provided with a connection part fixed to the front lower corner of the refrigerator. A valve stem is provided in the cylinder, and a flow port is provided on the valve stem. An inlet is further provided at the upper end of the cylinder, and a discharge nozzle is provided at the lower end. The flow port is located between the inlet and the discharge nozzle, and rotation of the valve stem can make the inlet and the discharge nozzle connected or closed. A handle is provided at the front end of the cylinder, and the front end of the valve stem is fixed on the handle.

The above technical solution is further configured as follows: a ring partition is provided in the end of the evaporator away from the handle, and the valve stem is provided with a lock head on one side of the ring partition, wherein the lock head is limited to rotate on the ring partition.

The middle part of the lock head is fixed on the valve stem, and an elastic limit plate is provided on the outer side of the lock head, and a hook edge is provided on the elastic limit plate.

The slush machine is further configured as follows: the rotating scraper structure includes at least three groups of straight scraper rods, and a rotating scraper is arranged between the straight scraper rods. The head of each straight scraper rod is gathered on the rotating scraper, and a head blade is arranged at the head end of the rotating scraper. The rotating direction of the head blade is along the rotating scraper, with the side of the rotating scraper facing the front is the first edge. The side of the straight scraper rod extending in the same direction as the first edge is the second edge, and a connecting platform is arranged between the head blades. A fixing hole is further arranged in the middle of the connecting platform, and the head blade is provided with a scraper notch for scraping the front side near the straight scraper rod.

The slush machine is further configured as follows: a box position is concavely provided on the upper side of the front end of the main body, and the refrigerator cover is installed in the box position. A refrigerator support seat is provided on the left and right sides of the lower side of the box position, and the lower part of the refrigerator cover is slidably provided on the refrigerator support seat and can only move forward and backward due to the limit thereof. Limiting protrusions are further provided at the rear edges of both sides of the refrigerator cover, and fixed covers are rotatably provided on both sides of the main body. The fixed covers are connected by a connecting rod, and a limiting groove is provided on the fixed cover. The opening of the limiting groove is directly opposite to the limiting protrusion, so that when the limiting groove rotates to a predetermined position, the limiting groove fixes the limiting protrusion to fix the refrigerator cover on the box position.

The slush machine is further configured as follows: a raised contact is provided on the rear side of the refrigerator cover, a through hole is provided on the main body at the mating position of the raised contact, and a micro switch is provided in the main body directly opposite to the through hole. The raised contact triggers the micro switch when the refrigerator cover is located in the box position.

The slush machine is further configured as follows: a track groove is concavely provided on the inner side of the refrigerator support seat, and a track bar is convexly provided on the refrigerator cover. The refrigerator cover is slidably provided on the refrigerator support seat in such a manner that the track bar slides in the track groove.

Compared with the prior art, the beneficial effects of the present invention are as follows:
1. The present invention changes the original refrigerant line-contact conduction mode into a surface-contact conduction mode, which effectively solves the problems of poor contact and low conduction efficiency between the coil and the outer barrel. Thus, the refrigeration medium quickly absorbs heat from the outer barrel, thereby accelerating the condensation effect and improving the refrigeration efficiency;
2. Configuration of the refrigeration unit as a barrel reduces materials and saves costs compared with manufacturing a coil;
3. Blockage of slush at the outlet in the disclosed slush machine is reduced via an optimized structure that reduces the possibility of slush accumulation and retention. Additionally, scraping is more uniform, which can make the slush delicate, improving the taste and quality. The optimized structure additionally converts raw materials into slush more quickly, shortening production time, and improving efficiency.

### BRIEF DESCRIPTION OF THE DRAWINGS

FIG. 1 is a schematic diagram of the structure of the present invention.

FIG. 2 is a schematic diagram of the structure of the ice maker cover opened.

FIG. 3 is a schematic diagram of the cross-sectional structure of the present invention.

FIG. 4 is a schematic diagram of the installation structure of the liquid guide member on the inner barrel.

FIG. 5 is a schematic diagram of the cross-sectional structure of the liquid guide member in the refrigeration chamber in Example 1.

FIG. 6 is an enlarged schematic diagram of the structure of the A part in FIG. 1.

FIG. 7 is an enlarged schematic diagram of the structure of the B part in FIG. 1.

FIG. 8 is a schematic diagram of the cross-sectional structure of the liquid guide member in the refrigeration chamber in Example 2.

FIG. 9 is a schematic diagram of the structure of the liquid inlet tank in Example 3.

FIG. 10 is a schematic diagram of the position structure of the liquid outlet in Example 4.

FIG. 11 is a schematic diagram of the cross-sectional view of the discharge structure.

FIG. 12 is a schematic diagram of the discharge structure.

FIG. 13 is a schematic diagram of the discharge structure in another direction.

FIG. 14 is a schematic diagram of the decomposition of the discharge structure.

FIG. 15 is a schematic diagram of the open state of the discharge structure.

FIG. 16 is a schematic diagram of the installation state of the rotating scraper structure.

FIG. 17 is a schematic diagram of the rotating scraper structure.

FIG. 18 is a schematic cross-sectional view of the rotating scraper structure.

FIG. 19 is a schematic diagram of the installation state of the rotating scraper structure in Example 5.

FIG. 20 is a schematic diagram of the rotating scraper structure in Example 5.

FIG. 21 is a schematic cross-sectional view of the rotating scraper structure in Example 5.

FIG. 22 is a schematic diagram of the refrigerator cover.

FIG. 23 is a schematic diagram of the fixing structure of the refrigerator cover.

FIG. 24 is a schematic diagram of the fixing structure of the refrigerator cover from another angle.

FIG. 25 is a perspective schematic diagram of the micro switch of the refrigerator cover.

FIG. 26 is an exploded schematic diagram of the refrigerator cover.

The attached drawings are marked as follows: 100, outer cylinder;
200, inner cylinder; 210, folded edge; 211, notch;
300, mounting bracket; 310, mounting ring;
400, liquid inlet pipe;
500, sealing ring;
600, exhaust pipe;
700, liquid guide member; 710, liquid guide bottom; 720, liquid guide wall; 730, flange; 701, liquid outlet;
800, shaft tube;
900, end cover;
1, main body; 2, ice maker cover; 3, thermostat; 6, cylinder; 7, connecting part; 8, valve stem; 9, flow port; 10, inlet; 11, discharge nozzle; 12, handle; 13, stud body; 14, column foot; 15, ring partition; 16, lock head; 17, elastic limit plate; 18, Hook edge; 19, sealing ring; 20, open mouth;
23, straight scraper rod; 24, rotating scraper; 25, head blade; 26, first edge; 27, second edge; 28, connecting platform; 29, fixing hole; 30, scraper notch; 31, rotating part; 32, flat sheet; 33, extension guard plate; 34, tail ring;
35, refrigerator support seat; 36, limit protrusion; 37, fixed cover; 38, connecting rod; 39, limit groove; 40, track groove; 41, track bar; 42, limit male head; 43, limit female head; 44, perforation; 45, micro switch; 46, rotating rod; 47, round head; 48, indicator; 49, switch mark; 50, serving plate;
a, refrigeration chamber; b, liquid inlet tank; c, liquid gap; b, insulation space.

### DETAILED DESCRIPTION OF EMBODIMENTS

In order to further explain the technical means and effects adopted by the present invention to achieve the predetermined invention purpose, the specific implementation method, structure, characteristics and effects of the present invention are described in detail below in combination with the accompanying drawings and preferred embodiments.

### Embodiment 1

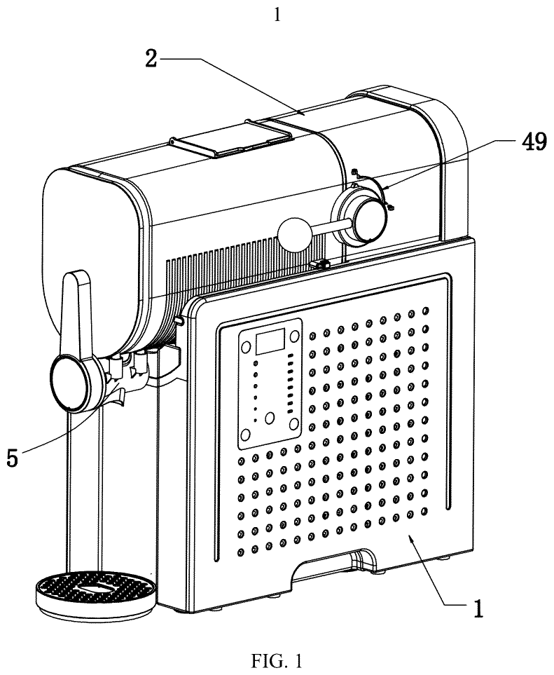

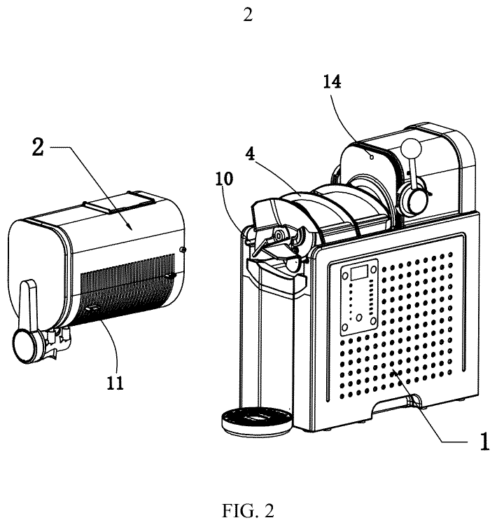

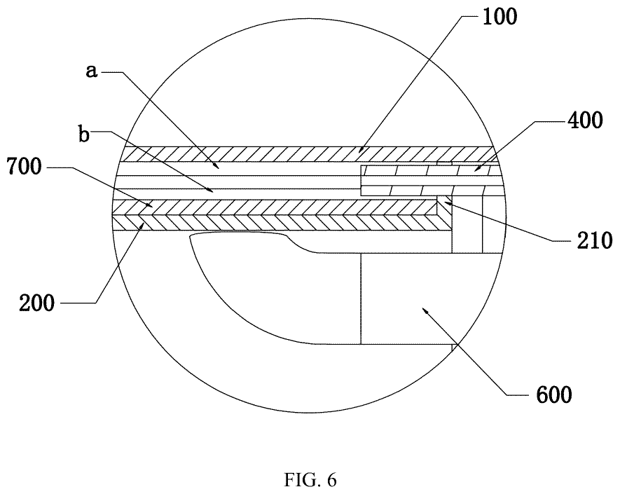

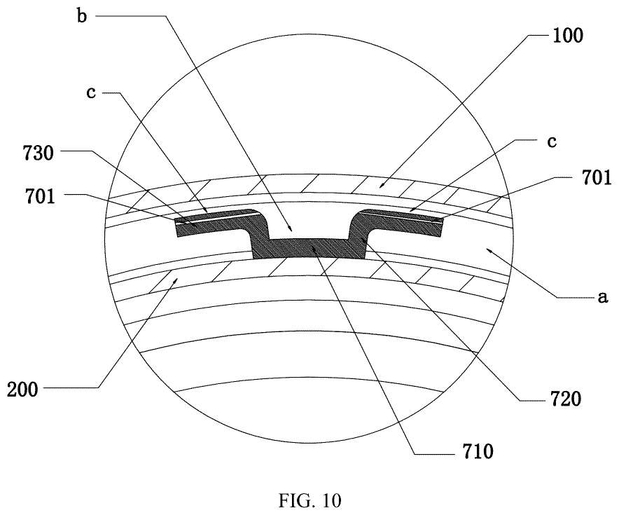

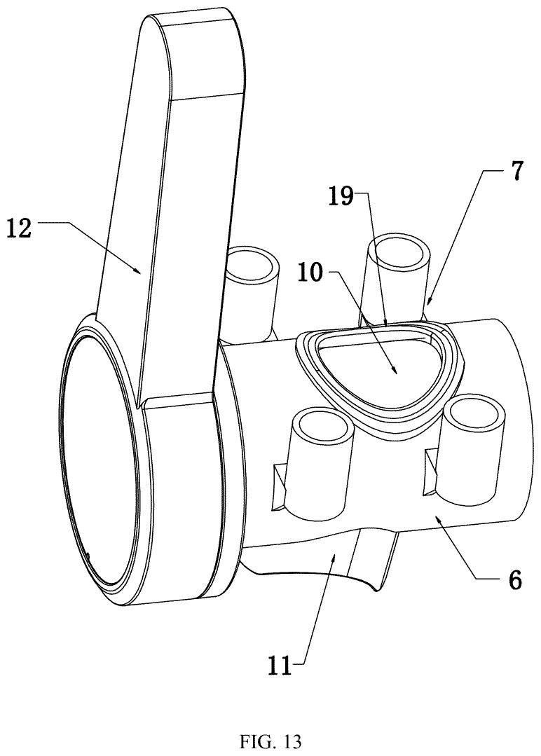

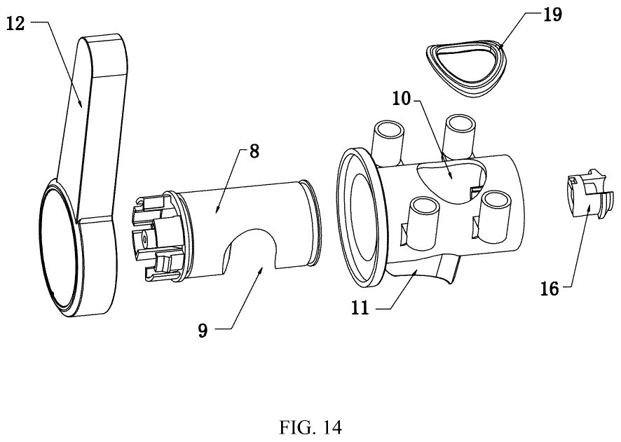

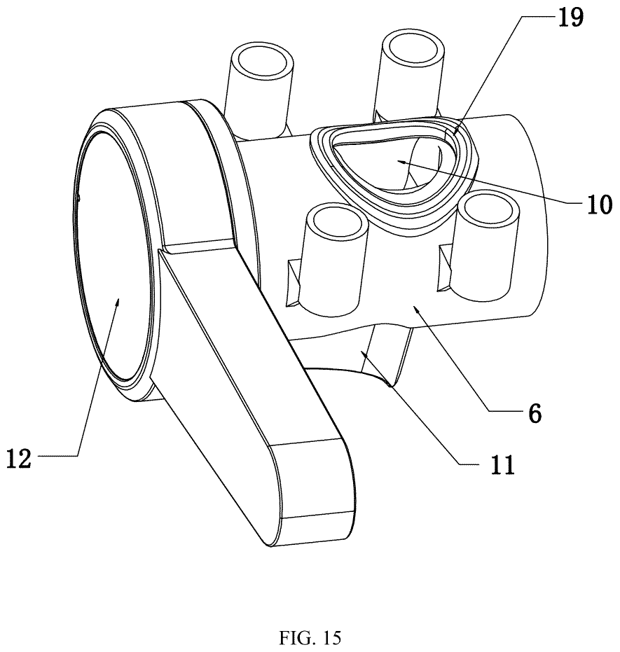

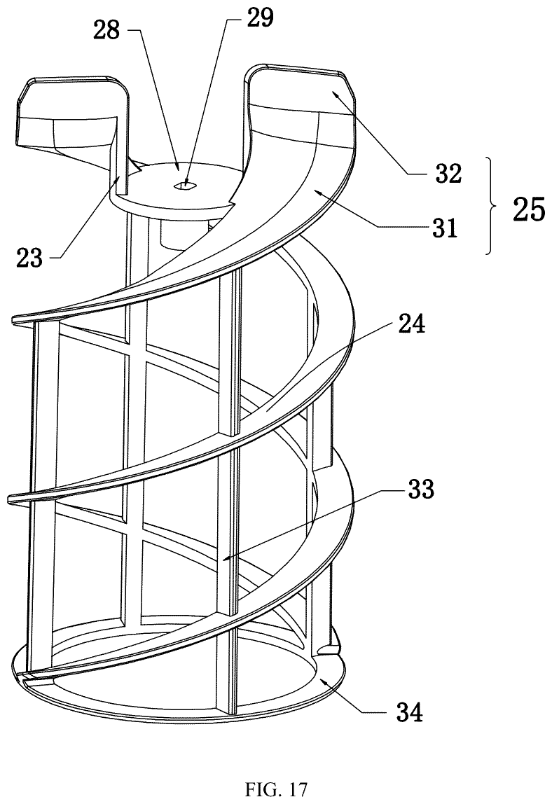

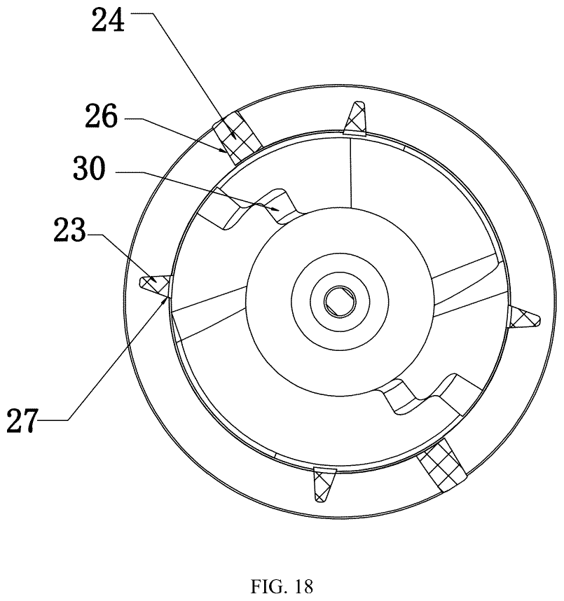

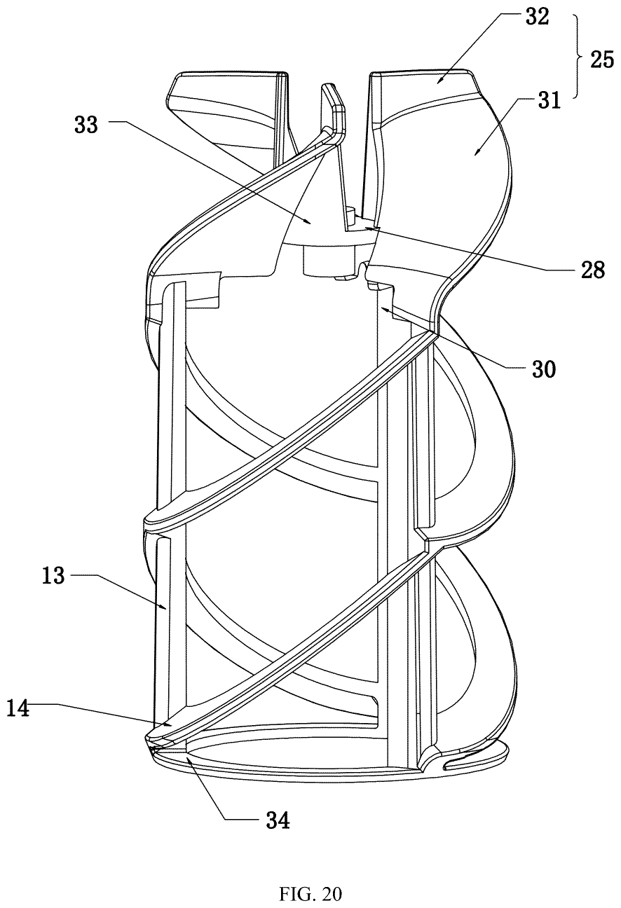

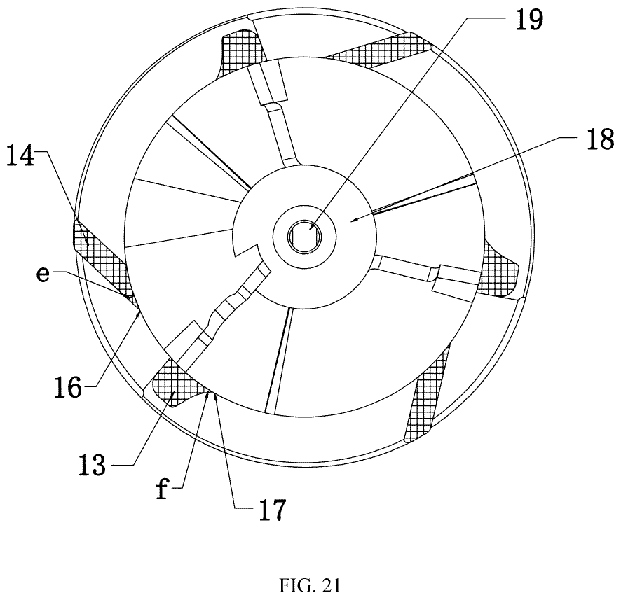

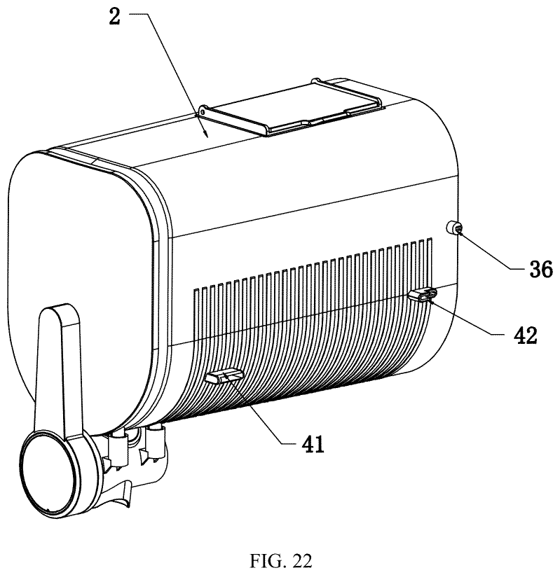

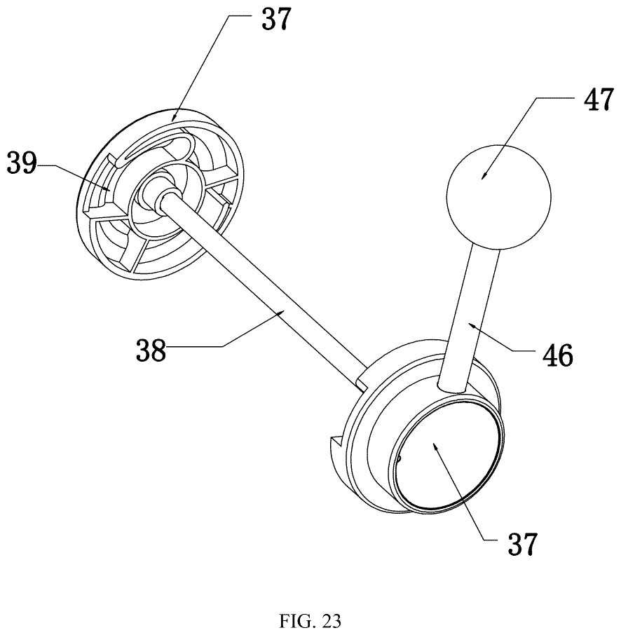

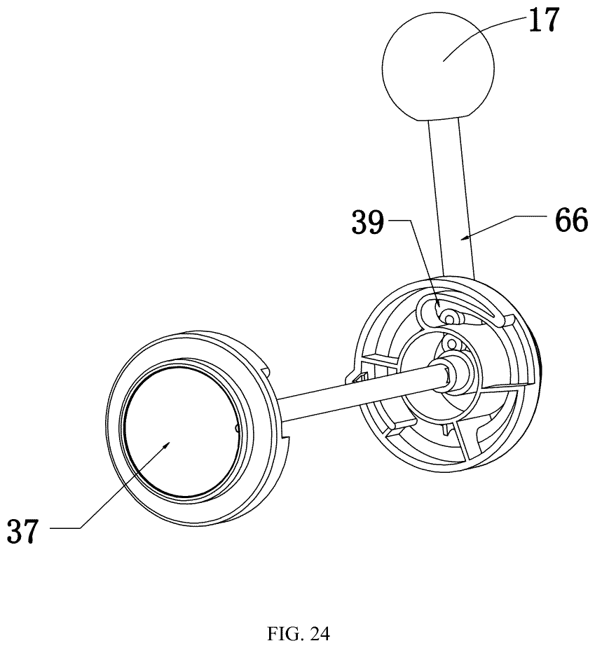

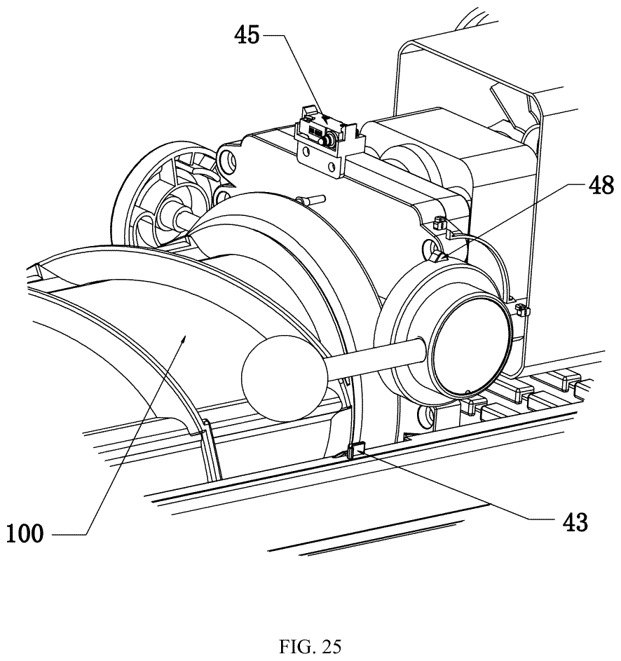

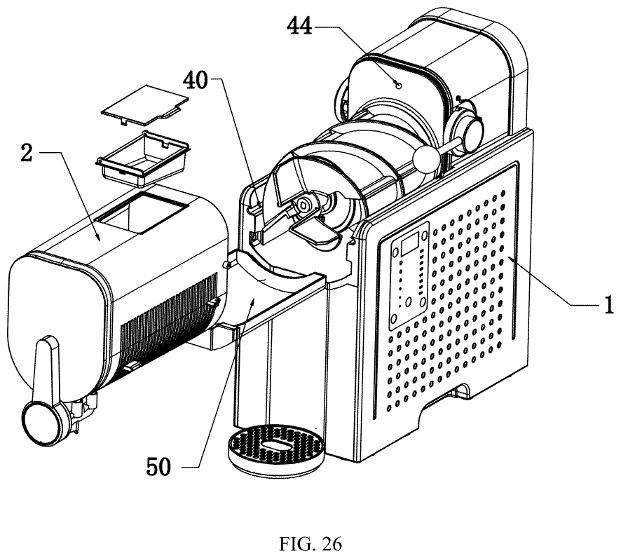

As shown in FIGS. 1-26, a slush machine comprises a main body 1 and a refrigerator cover detachably fixed on the main body 1, wherein a refrigeration system is arranged in the main body 1, wherein the evaporator of the refrigeration system is connected to be refrigerated by the evaporator, and the rotating scraper structure scrapes off the condensation on the outer surface of the evaporator; the main body 1 also comprises a discharging structure; and an inner cylinder 200 is also comprised of a cylindrical shell with openings at both ends and coaxial with the outer cylinder 100, wherein the first end is connected to the end of the outer cylinder 100, and the second end is provided with a folded edge 210 outwardly, so that a closed refrigeration chamber a is formed between the inner cylinder 200 and the outer cylinder 100;

The folded edge 210 is provided with a notch 211, and the refrigeration chamber a is provided with a liquid inlet groove b connected with the notch 211, and the refrigeration medium enters the refrigeration chamber a through the liquid inlet groove b; and the liquid inlet pipe 400 extends into the liquid inlet groove b through the notch 211.

The above is the basic scheme of this embodiment.

Specifically referring to FIGS. 1 to 4, the evaporator and the rotary scraper structure are located inside the main body 1 and are closed by the refrigerator cover;

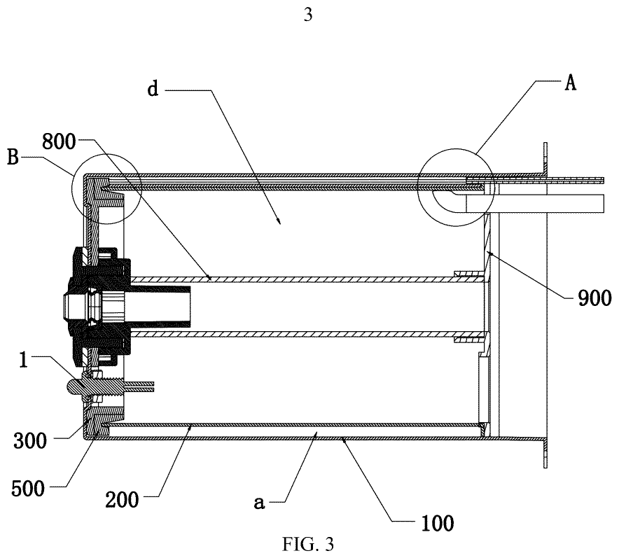

As shown in FIG. 3, the outer cylinder 100 is set as a shell with an opening at one end and a bottom at the other end, and the inner cylinder 200 is located inside the outer cylinder 100 and is coaxially arranged with the outer cylinder 100. The inner cylinder 200 can be directly welded to the bottom of the outer cylinder 100, or can be sealed and connected to the outer cylinder 100 through the connecting part 7;

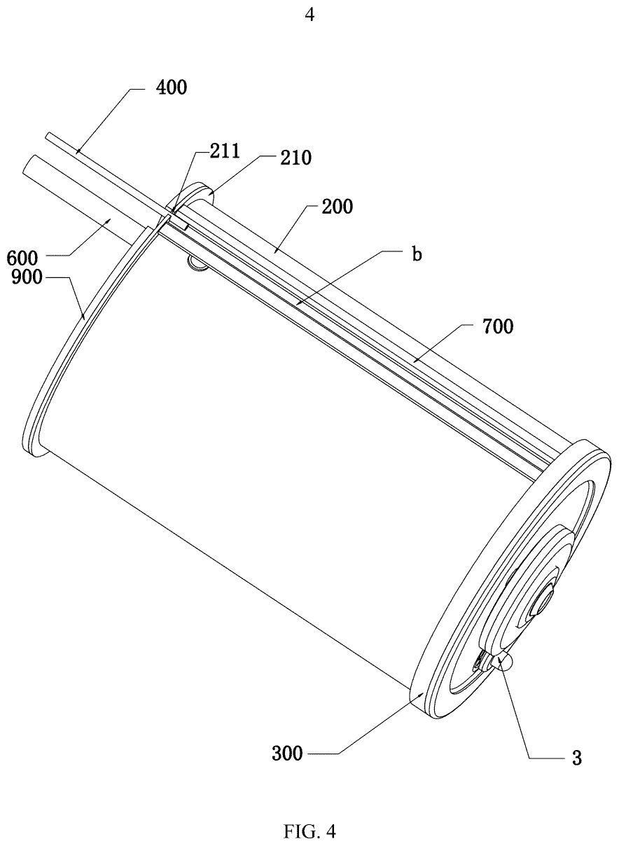

As shown in FIG. 4, the second end of the outer cylinder 100 is folded outward and provided with a folded edge 210, and the outer end of the folded edge 210 is connected to the inner wall of the outer cylinder 100, so that a closed refrigeration chamber a is formed between the inner cylinder 200 and the outer cylinder 100;

At the same time, a notch 211 is provided on the folded edge 210, and a liquid inlet groove b is provided in the refrigeration chamber a and communicates with the notch 211 on the folded edge 210;

The liquid inlet pipe 400 extends into the liquid inlet groove b through the notch 211;

The refrigeration medium is input into the liquid inlet groove b through the liquid inlet pipe 400, and enters the refrigeration chamber a along the liquid inlet groove b;

The refrigeration medium acts in the refrigeration chamber a, refrigerating the outer cylinder 100, and the liquid condenses on the surface of the outer cylinder 100 due to cold, and is scraped off by the scraper on the side of the outer cylinder 100. In this embodiment, an end cap 900 is provided at one end of the opening of the outer cylinder 100 for sealing.

In this embodiment, the refrigeration medium is a conventional refrigerant.

In this embodiment, the liquid inlet pipe 400 is a capillary tube, and the size of the notch 211 can at least accommodate the extension of the liquid inlet pipe 400.

In this embodiment, the refrigerant is continuously input into the refrigeration chamber a and contacts the inner surface of the outer cylinder 100. The contact area is the entire inner surface of the outer cylinder 100. Compared with the spiral tube, the contact area of this embodiment is large and the refrigeration effect is good;

When the refrigerant works in the refrigeration chamber a, it absorbs the heat on the outer cylinder 100 and vaporizes to form gas. In order to avoid the gas filling in the refrigeration chamber a and affecting the input of the refrigerant, in this embodiment, the refrigeration chamber a is also connected to the exhaust pipe 600, and the formed gas is output to the outside of the refrigeration chamber a through the exhaust pipe 600, so that the refrigeration chamber a can continuously receive the refrigerant.

During use, the refrigerant is continuously input into the refrigeration chamber a from the liquid inlet tank b, and the vaporized gas is output from the exhaust pipe 600 to form a cycle, so that the heat of the liquid can be continuously absorbed to ensure the refrigeration effect of the evaporator.

In this embodiment, a liquid guide member 700 is provided in the refrigeration chamber a, and the liquid inlet tank b is located on the liquid guide member 700; at least one end of the liquid inlet tank b is open to the gap 211.

4 and 6, in this embodiment, the liquid guide member 700 is set to be a long strip, the liquid inlet groove b is a recessed portion provided on the surface of the liquid guide member 700, and at least one end of the liquid inlet groove b is open and connected to the notch 211.

The refrigerant enters the liquid inlet groove b through the notch 211 on the folded edge 210, flows along the liquid inlet groove b, flows out at the notch of the liquid inlet groove b, and enters the refrigeration chamber a;

To ensure the smooth outflow of the refrigerant medium, in this embodiment, a gap is left between the end of the groove wall of the liquid inlet groove b and the inner wall of the outer cylinder 100.

In other embodiments, both ends of the liquid inlet groove b can also be set to be open, and the refrigerant can also flow out from the other end opening of the liquid inlet groove b into the refrigeration chamber a.

In this embodiment, the liquid guide member 700 includes at least a liquid guide bottom 710 connected to the outer wall of the inner cylinder 200 and a liquid guide wall 720 formed on both sides of the liquid guide bottom 710, and the liquid inlet groove b is located between the liquid guide bottom 710 and the liquid guide wall 720;

The end of the liquid guide wall 720 is folded outward and provided with a flange 730.

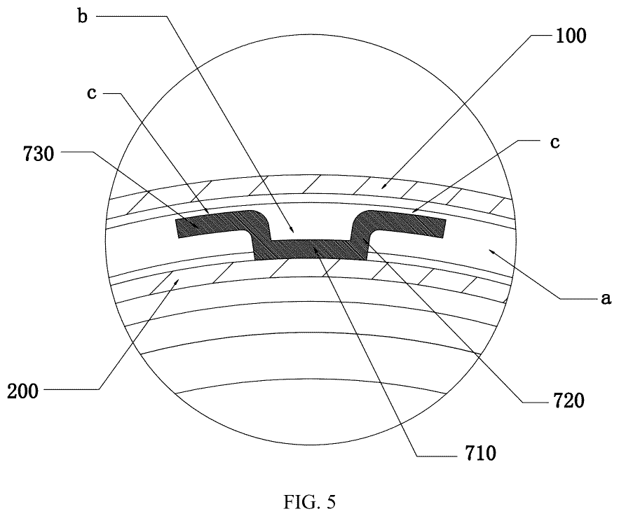

As shown in FIG. 5, the outer end surface of the liquid guide bottom 710 is fixed on the outer wall of the inner cylinder 200, and is fixedly connected with the inner cylinder 200;

There is a liquid gap c between the flange 730 and the inner wall of the outer cylinder 100, and the refrigerant can overflow from the liquid gap c to the refrigeration chamber a.

Preferably, in order to ensure that the refrigerant can pass through the liquid inlet pipe 400, the liquid inlet groove b and the liquid gap c in sequence, in this embodiment, the opening of the pipe mouth of the liquid inlet pipe 400 is completely located in the liquid inlet groove b.

In this embodiment, the liquid guide bottom 710 and the inner cylinder 200 are welded and fixed.

In this embodiment, a flange 730 is provided so that a liquid gap c with a width much smaller than that of the refrigeration chamber a is formed between the flange 730 and the inner wall of the outer cylinder 100. When the refrigerant overflows from the liquid inlet groove b, it must enter the liquid gap c, that is, it first directly contacts the inner wall of the outer cylinder 100, so that the outer cylinder 100 can be directly refrigerated.

In this embodiment, at least one liquid inlet groove b is provided, and the number of notches 211 on the flange 210 is the same as the number of liquid inlet grooves b.

In order to increase the input speed of the refrigerant medium, multiple liquid guide members 700 can be provided on the surface of the inner cylinder 200, so as to provide multiple liquid inlet grooves b and matching notches 211 for the introduction of the refrigerant medium.

When in use, the cylinder 6 is usually placed lying down. At this time, the liquid gap c between the flange 730 and the outer cylinder 100 is located at the upper and lower ends of the liquid inlet tank b. When the liquid inlet pipe 400 inputs the refrigerant into the liquid inlet tank b, due to the effect of gravity, the refrigerant is output from the liquid gap c below and evenly distributed along the inner wall of the outer cylinder 100, so that the outer cylinder 100 can be quickly vaporized and heat absorbed, and the outer cylinder 100 can be cooled to achieve a rapid cooling effect.

In this embodiment, the exhaust pipe 600 passes through the wall of the inner cylinder 200 and extends from the middle part of the inner cylinder 200 to connect the refrigeration chamber a with the external space.

In this embodiment, the exhaust pipe 600 extends from the end cover 900 to discharge the gas to the external space.

In this embodiment, when the refrigerant medium acts in the refrigeration chamber a, it will absorb the heat on the wall of the outer cylinder 100 and the wall of the inner cylinder 200 at the same time, and has a cooling effect on both the outer cylinder 100 and the inner cylinder 200; therefore, when the air in the center of the inner cylinder 200 contacts the wall of the inner cylinder 200, pre-cooling and liquefaction will produce water droplets. In this embodiment, a heat preservation space b is provided at the center of the inner cylinder 200, and the heat preservation space b is filled with heat preservation material.

As shown in FIG. 3, the heat preservation material is filled into the heat preservation space b, occupying the space in the center of the inner cylinder 200, reducing the contact between the air and the inner cylinder 200, thereby avoiding the liquefaction of the air on the surface of the inner cylinder 200;

In addition, when the heat preservation material is filled in the center of the inner cylinder 200, the surface of the inner cylinder 200 cannot dissipate heat, which maximizes the refrigeration effect.

In this embodiment, a rotating shaft tube 800 is arranged at the center of the inner cylinder 200, and the heat preservation space b is located between the rotating shaft tube 800 and the inner cylinder 200, and the end of the rotating shaft tube 800 is connected to the mounting bracket 300 and the end cover 900.

In this embodiment, in order to ensure the sealing effect of the refrigeration chamber a, a mounting bracket 300 is also included, and the mounting bracket 300 is provided with the bottom of the outer cylinder 100, and the first end of the inner cylinder 200 is connected to the mounting bracket 300; the mounting bracket 300 is provided with a mounting ring 310 extending along the axial direction, and a mounting groove is formed between the mounting ring 310 and the inner wall of the outer cylinder 100;

A sealing ring 500 is arranged in the mounting groove, and the first end of the inner cylinder 200 is connected to the sealing ring 500.

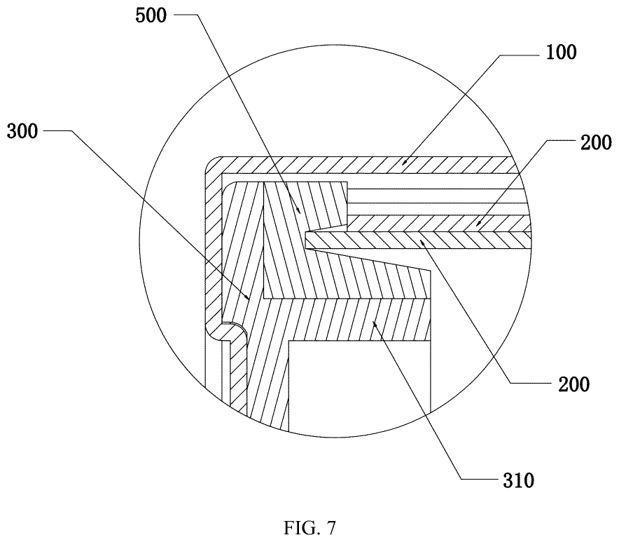

As shown in FIGS. 4 and 7, the mounting bracket 300 is located inside the outer cylinder 100 and is arranged on the bottom. At the same time, it is sealed and connected to the inner wall of the outer cylinder 100 through a sealing ring 500;

The first end of the inner cylinder 200 is connected to the mounting bracket 300;

The end surface of the sealing ring 500 is provided with an embedding groove, and the first end of the inner cylinder 200 is inserted into the embedding groove, thereby realizing the connection with the sealing ring 500;

A part of the sealing ring 500 located outside the embedding groove enters the refrigeration chamber a, sealing one end of the refrigeration chamber a, and the other end is sealed by the folding edge 210.

In this embodiment, the outer cylinder 100 is provided with a thermostat 3.

As shown in FIG. 3, the temperature measuring head of the thermostat 3 passes through the bottom of the outer cylinder 100 and the mounting bracket 300 to measure and monitor the temperature in the insulation space b.

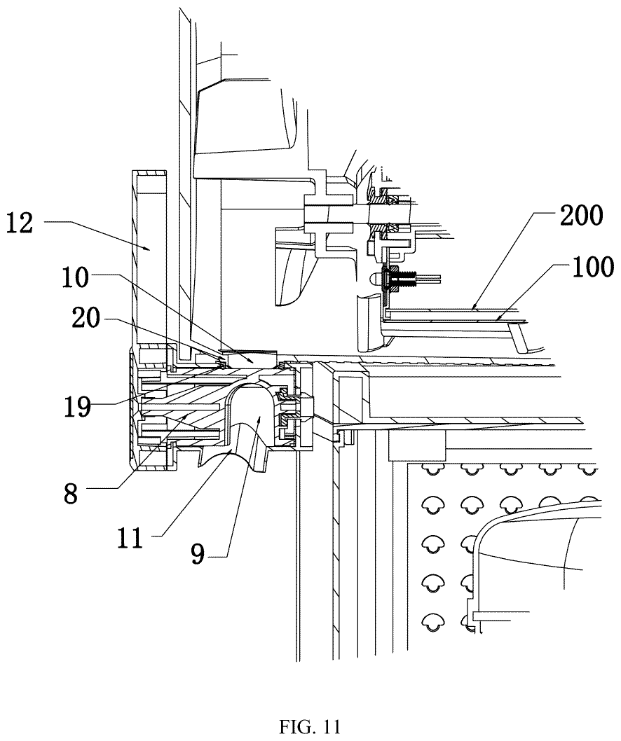

As shown in FIGS. 11-15, in this embodiment, the discharge structure is a horizontal cylinder 6, and the outer end of the cylinder 6 is provided with a connecting part 7 fixed to the front lower corner of the refrigerator; a valve stem 8 is provided in the cylinder 6, and a flow port 9 is provided on the valve stem 8. The upper end of the cylinder 6 is provided with an inlet 10, and the lower end is provided with a discharge nozzle 11. The flow port 9 is located between the inlet 10 and the discharge nozzle 11, and the rotation of the valve stem 8 can make the inlet 10 and the discharge nozzle 11 connected or closed; a handle 12 is provided at the front end of the cylinder 6, and the front end of the valve stem 8 is fixed on the handle 12.

In order to facilitate and reliable fixation, the connecting part 7 is a plurality of symmetrical stud bodies 13, and the stud body 13 is screwed with a screw extending outward, and the other end of the screw is fixed on the main body 1.

Further, the stud bodies 13 are provided with 4, and are symmetrically located on both sides of the cylinder 6 in pairs, and the stud bodies 13 are connected to the cylinder 6 through the column foot 14.

In order to facilitate the rotatable installation of the valve stem 8, a ring partition 15 is provided in the end of the cylinder 6 away from the handle 12, and a lock head 16 is provided on one side of the ring partition 15 of the valve stem 8, and the lock head 16 limits rotation on the ring partition 15.

Further limiting, the middle part of the lock head 16 is fixed on the valve stem 8, and an elastic limiting piece 17 is provided on the outer side of the lock head 16, and a hook edge 18 is provided on the elastic limiting piece 17. The hook edge 18 is engaged on the ring partition 15.

For the convenience of sealing, a sealing ring 19 is provided on the edge of the inlet 10.

Matching arrangement, an opening is provided on the lower side of the front end of the main body 1, and the inlet 10 of the cylinder 6 is attached to the opening, and the sealing ring 19 seals the gap between the opening and the inlet 10 to ensure sealing.

Further, the outer edge of the opening extends to form an opening mouth 20, and the front end shape of the opening mouth 20 is consistent with the shape of the inlet 10 of the cylinder 6.

A preferred arrangement of the leaking part 9, wherein the leaking part 9 has a U-shaped notch 211.

When in use, by simply rotating the handle, the U-shaped notch 211 of the leaking part 9 changes from being closed to being connected to the inlet 10 and the discharge nozzle 11, and the step of discharging the slush can be completed.

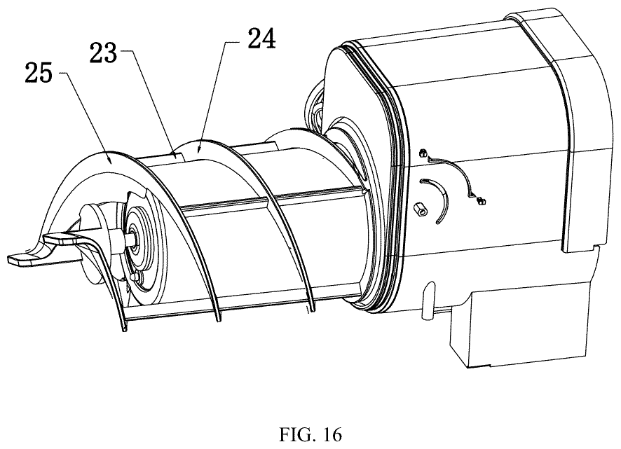

Specifically referring to FIGS. 16 to 18, in this embodiment, the rotating scraper structure includes at least three groups of straight scraper rods 23, and rotating scrapers 24 are arranged between the straight scraper rods 23. The head of the straight scraper rod 23 is gathered on the rotating scraper 24, and a head blade 25 is arranged at the head end of the rotating scraper 24; the rotation direction of the head blade 25 is along the rotating scraper 24, the edge of the rotating scraper 24 facing the front is the first edge 26, and the side of the straight scraper rod 23 in the same direction as the first edge 26 is the second edge 27, and a connecting platform 28 is arranged between the head blades 25, and a fixing hole 29 is arranged in the middle of the connecting platform 28; the head blade 25 is provided with a scraper notch 211 for scraping the front side near the straight scraper rod 23.

A preferred embodiment with better ice delivery effect, the straight scraper rod 23 is provided with 4 groups, and the rotating scraper 24 and the head blade 25 are provided with 2 groups and are arranged in a double helix.

In order to improve the head feeding effect, the width of the head blade 25 is radially greater than the thickness of the straight scraper rod 23.

Further preferably, the head blade 25 includes a rotating part 31 and an outer flat sheet part 32, and the front end of the flat sheet part 32 is flat.

In order to make the direction of slush accumulation tend to the outside and not stick to the front side, the front side of the connecting platform 28 is provided with an extension guard plate 33, and the front end of the extension guard plate 33 is connected and fixed to the edge of the rotating part 31.

In order to improve the strength of the scraper, a tail ring 34 is provided at the tail of the straight scraper rod 23, and the tail end leaves of a group of rotating scrapers 24 on the rear side are connected to the tail ring 34.

Further, the connection point where the tail end leaves of the rotating scraper 24 are connected to the tail ring 34 is at the connection between the straight scraper rod 23 and the tail ring 34.

When in use, this embodiment is installed on the ice column with the rotating scraper 24 structure of the prior art. The motor is connected to the connecting platform 28 to drive the rotating scraper structure to rotate. The rotating scraper 24 and the straight scraper rod 23 work together to scrape off the ice layer on the ice column to form slush. Then, the slush enters the space of the head blade 25 on the front side under the drive of the rotating scraper 24, and is discharged through the feeding head under the rotation of the head blade 25.

Specifically referring to FIGS. 1 and 22-26, a box position is recessed on the upper side of the front end of the main body 1, and the refrigerator cover is installed in the box position; refrigerator support seats 35 are provided on the left and right sides of the lower side of the box position, and the lower part of the refrigerator cover is slidably arranged on the refrigerator support seats 35 and can only move forward and backward due to the limit; limiting protrusions 36 are provided at the rear edges of both sides of the refrigerator cover, and fixed covers 37 are rotatably provided on both sides of the main body 1, and the fixed covers 37 are connected by a connecting rod 38, and the fixed covers 37 are provided with limiting grooves 39, and the opening of the limiting grooves 39 is opposite to the limiting protrusions 36, so that when the limiting grooves 39 rotate to the predetermined position, the limiting grooves 39 fix the limiting protrusions 36 to fix the refrigerator cover on the box position.

A preferred sliding arrangement of a refrigerator cover, wherein a track groove 40 is concavely provided on the inner side of the refrigerator support seat 35, and a track bar 41 is convexly provided on the refrigerator cover. The refrigerator cover is limitedly slidably provided on the refrigerator support seat 35 in such a manner that the track bar 41 is slidably provided in the track groove 40.

In order to prevent the rear side of the refrigerator cover from hitting the main body, a limit male head 42 is convexly provided on the refrigerator cover, and a limit female head 43 is provided on the refrigerator support seat 35. When the refrigerator cover reaches the box position, the limit male head 42 abuts against the limit female head 43.

In order to prevent idling without a cover, a raised contact is provided on the rear side of the refrigerator cover, and a through hole 44 is provided on the main body 11 at the mating position of the raised contact. A micro switch 45 is provided in the main body 1 opposite to the through hole 44. When the refrigerator cover is located in the box position, the raised contact triggers the micro switch 45.

A preferred embodiment of a fixed cover 37, a rotating rod 46 is provided on the fixed cover 37.

To further facilitate operation, a round head 47 is provided on the top of the rotating rod 46.

In order to display the state of the box cover, an indicator 48 is provided on the fixed cover 37 provided with the rotating rod 46, and a switch mark 49 is provided on the main body 1 at the position corresponding to the indicator 48.

A preferred embodiment, the lower side of the refrigerator cover is semicircular.

In order to prevent the material from contaminating the main body 1 during the removal of the cover, a serving plate 50 is also provided on the main body 1 below the refrigerator cover, and the serving plate 50 can be pulled out after the refrigerator cover is removed.

Further, both sides of the serving plate 50 are installed on the refrigerator support seat 35.

In this embodiment, as long as the fixed cover 37 is rotated during use, the limiting protrusion 36 passes through the curved path of the limiting groove 39 and is exposed in the opening, and the refrigerator cover can be pulled out horizontally from the box position. If the fixed cover 37 is rotated to the depth of the limiting groove 39, the refrigerator cover will be tightly fixed on the main body 1.

### Example 2

This example is an improvement made on the basis of Example 1, and its purpose is to accelerate the input of the refrigerant medium. The specific implementation method is as follows:

The liquid guide member 700 is provided with a plurality of liquid outlet holes 701 connected to the liquid inlet groove b;

The liquid outlet holes 701 are arranged on the liquid guide wall 720.

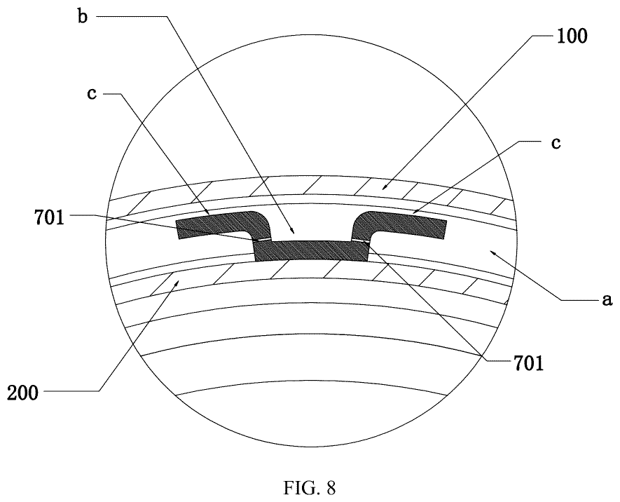

Preferably, as shown in FIG. 8, in this example, the liquid outlet holes 701 are arranged on the groove wall of the liquid inlet groove b, that is, the refrigerant medium entering the liquid inlet groove b can be directly output from the liquid outlet holes 701 on the liquid guide wall 720 to the refrigeration chamber a.

### Example 3

This example provides a new structure of the liquid inlet groove b, and its specific implementation method is as follows: the liquid inlet groove b is a spiral recessed portion arranged on the outer wall of the inner cylinder 200.

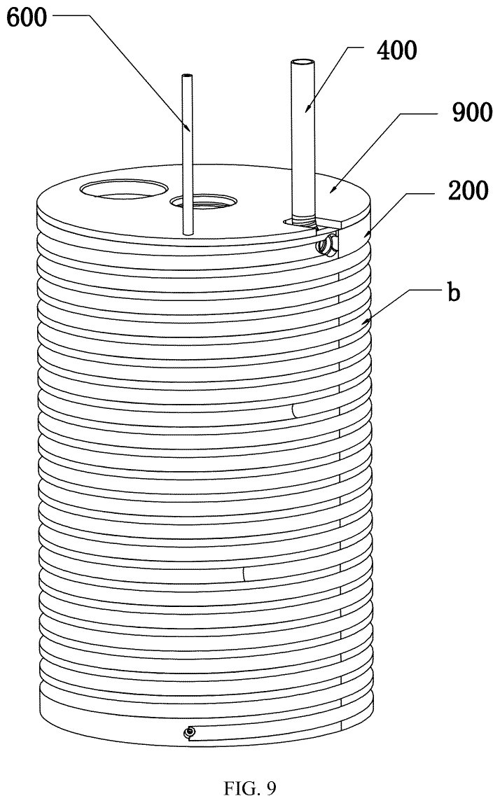

Specifically, as shown in FIG. 9, the liquid inlet groove b is spirally recessed on the outer wall of the inner cylinder 200, and the liquid inlet pipe 400 is connected to one end of the liquid inlet groove b, and the exhaust pipe 600 is connected to the other end of the liquid inlet groove bb.

The refrigerant enters the liquid inlet groove bb through the liquid inlet pipe 400, flows toward the other end along the spiral shape, contacts the inner wall of the outer cylinder 100 during the flow, absorbs the heat of the outer cylinder 100, and at the same time, squeezes the air in the refrigeration chamber a toward the exhaust pipe 600, and discharges the air from the exhaust pipe 600.

### Example 4

This example is an improvement made on the basis of Example 3, the purpose is to accelerate the input of the refrigerant medium, and the specific implementation method is as follows:

The liquid guide member 700 is distributed with a plurality of liquid outlet holes 701 connected to the liquid inlet groove b;

The liquid outlet hole 701 is arranged on the flange 730.

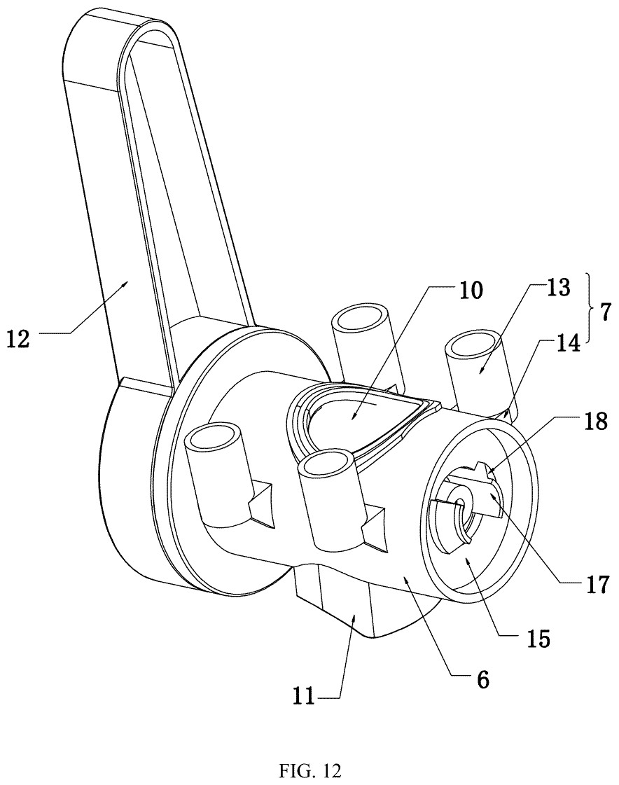

Preferably, as shown in FIG. 12, in this embodiment, the liquid outlet hole 701 is arranged on the flange 730, and the direction is along the circumference of the inner cylinder 200, and overflows from the liquid inlet groove b to both sides.

When the refrigerant in the liquid inlet groove b fills the entire liquid inlet groove b, the refrigerant on the inner side of the flange 730 overflows to both sides through the liquid outlet hole 701, thereby accelerating the speed at which the refrigerant enters the refrigeration chamber a;

Compared with the liquid outlet hole 701 disposed on the liquid guide wall 720, in this embodiment, the position of the liquid outlet hole 701 is closer to the inner wall of the outer cylinder 100, so that it can contact the outer cylinder 100 more quickly and cool the outer cylinder 100.

### Example 5

This example is an improvement on the rotating scraper structure in Example 1, and aims to provide another specific test method of the rotating scraper:

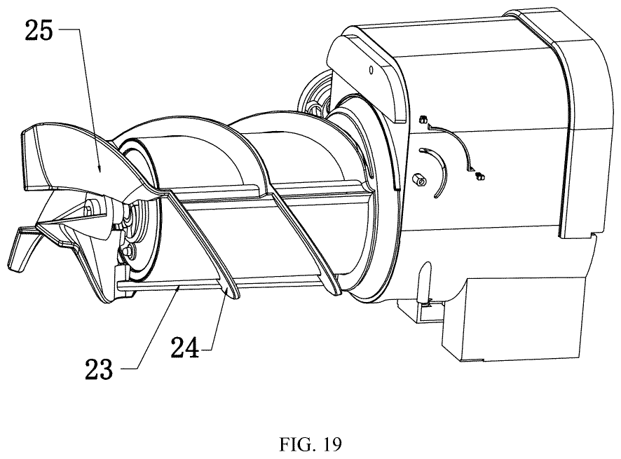

Specifically referring to FIGS. 19-21, a rotating scraper structure of a slush maker includes at least three groups of straight scraper rods 23, and a rotating scraper 24 is arranged between the straight scraper rods 23. The head of the straight scraper rod 23 is gathered on the rotating scraper 24, and a head blade 25 is arranged at the head end of the rotating scraper 24; the rotation direction of the head blade 25 is along the rotating scraper 24, and the side of the rotating scraper 24 facing the front is the first edge 26, and the side of the straight scraper rod 23 in the same direction as the first edge 26 is the second edge 27, and a connecting platform 28 is arranged between the head blades 25, and a fixing hole 29 is arranged in the middle of the connecting platform 28; the head blade 25 is provided with a scraper notch 211 for scraping the front side near the straight scraper rod 23.

A preferred method for achieving a better scraping effect is that the straight scraper bar 23 is provided with three groups, and the rotating scraper 244 and the head blade 25 are provided with three groups.

Further, the blade angle e of the first edge 26 is 23 degrees, and the blade angle f of the second edge 27 is 32 degrees.

In order to improve the head feeding effect, the width of the head blade 25 is radially greater than the thickness of the straight scraper bar 23.

Further preferably, the head blade 25 includes a rotating part 31 and an outer flat sheet part 32, and the front end of the flat sheet part 32 is flat.

In order to make the direction of slush accumulation tend to the outside and not stick to the front side, the front side of the connecting platform 28 is provided with an extension guard plate 33, and the front end of the extension guard plate 33 is connected and fixed to the edge of the rotating part 31.

In order to improve the strength of the scraper, a tail ring 34 is provided at the tail of the straight scraper bar 23, and the tail end leaves of the rear group of rotating scrapers 24 are connected to the tail ring 34.

Furthermore, the connection point of the tail blade of the rotating scraper 24 to the tail ring 34 is at the connection point between the straight scraper rod 23 and the tail ring 34.

The above is only a preferred embodiment of the present invention, and does not limit the present invention in any form. Although the present invention has been disclosed as a preferred embodiment as above, it is not used to limit the present invention. Any technical personnel in this field can make some changes or modify the technical content disclosed above to an equivalent embodiment of equivalent changes without departing from the scope of the technical solution of the present invention. However, any brief modification, equivalent change and modification made to the above embodiment based on the technical essence of the present invention without departing from the content of the technical solution of the present invention still falls within the scope of the technical solution of the present invention.

What is claimed is:

1. A slush machine comprising:
a main body comprising a discharge structure and a refrigerator cover detachably fixed to the main body;
wherein a refrigeration system is arranged in the main body, wherein an evaporator of the refrigeration system is connected to receive refrigeration medium, and wherein a rotating scraper structure scrapes off condensation on an outer surface of the evaporator;
wherein the evaporator comprises an outer barrel, wherein an interior of the outer barrel is filled with the refrigeration medium, and liquid is poured onto the outer surface of the outer barrel and condenses before being scraped off by the rotating scraper structure;
wherein the evaporator further comprises an inner barrel comprising a cylindrical shell having openings at a first end and a second end and being coaxial with the outer barrel, wherein a first end of the inner barrel is connected to an end of the outer barrel, and a second end of the inner barrel is provided with an outward-extending folded edge, wherein a closed refrigeration chamber is formed between the inner barrel and the outer barrel; wherein the outward-extending folded edge is provided with a notch, and a liquid inlet groove connected to the notch is provided in the refrigeration chamber, and wherein the refrigeration medium enters the refrigeration chamber through the liquid inlet groove via the liquid inlet pipe extending into the liquid inlet groove through the notch.

2. The slush machine according to claim 1, wherein a liquid guide member is provided in the refrigeration chamber, and the liquid inlet groove is located on the liquid guide member; and at least one end of the liquid inlet groove is open and connected to the notch.

3. The slush machine according to claim 2, wherein the liquid guide member at least includes a liquid guide bottom connected to the outer wall of the inner barrel and a liquid guide wall formed on both sides of the liquid guide bottom, wherein the liquid inlet groove is located between the liquid guide bottom and the liquid guide wall;
wherein an end of the liquid guide wall is folded outward and provided with a flange.

4. The slush machine according to claim 3, wherein a plurality of liquid outlet holes are distributed on the liquid guide component and connected to the liquid inlet groove;
wherein the liquid outlet holes are arranged on the liquid guide wall.

5. The slush machine according to claim 1, wherein the discharge structure is a horizontal cylinder, and an outer end of the cylinder is provided with a connecting part fixed to a front lower corner of the ice making machine;
wherein a valve stem is provided in the cylinder, a flow port is provided on the valve stem, an inlet is provided at an upper end of the cylinder, and a discharge nozzle is provided at a lower end;
wherein the flow port is located between the inlet and the discharge nozzle, and a rotation of the valve stem can make the inlet and the discharge nozzle connected or closed;
wherein a handle is provided at a front end of the cylinder, and a front end of the valve stem is fixed on the handle.

6. The slush machine according to claim 5, wherein a ring partition is provided inside the end of the evaporator away from the handle, the valve stem is provided with a lock head on one side of the ring partition, and the lock head limits rotation on the ring partition;
wherein the middle part of the lock is fixed on the valve stem, and an elastic limit plate is provided on the outer side of the lock, and a hook edge is provided on the elastic limit plate.

7. The slush machine according to claim 1, wherein the rotating scraper structure includes at least three groups of straight scraper rods and a rotating scraper is provided between the straight scraper rods;
and wherein the head of the straight scraper rod is converged on the rotating scraper, and a head blade is provided at the head end of the rotating scraper;
wherein the rotation direction of the head blade extends along the rotating scraper, the edge of the rotating scraper facing the front is the first edge, and a side of the straight scraper rod extending in the same direction as the first edge is the second edge;
wherein a connecting platform is provided between the head blades, and a fixing hole is provided in the middle of the connecting platform; and
wherein the head blade is provided with a scraper notch for scraping the front side near the straight scraper rod.

8. The slush machine according to claim 1, wherein a box position is concavely provided on an upper side of the front end of the main body, and the refrigerator cover is installed in the box position;
wherein a refrigerator support seat is provided on left right sides of a lower side of the box position, and a lower part of the refrigerator cover is slidably provided on the refrigerator support seat and can only move forward and backward due to limiting protrusions;
wherein the limiting protrusions are provided at rear edges of both sides of the refrigerator cover, and fixed covers are rotatably provided on both sides of the main body;
wherein the fixed covers are connected by a connecting rod, and a limiting groove is provided on each fixed cover, and wherein an opening of the limiting groove is directly opposite to a limiting protrusion, so that when the limiting groove rotates to a predetermined position, the limiting groove fixes the limiting protrusion to fix the refrigerator cover on the box position.

9. The slush machine according to claim 8, wherein a raised contact is provided on a rear side of the refrigerator cover, a through hole is provided on the main body at a mating position of the raised contact, and a micro switch is provided in the main body directly opposite to the through hole, and the raised contact triggers the micro switch when the refrigerator cover is located in the box position.

10. The slush machine according to claim 8, wherein a track groove is concavely provided on an inner side of the refrigerator support seat,
wherein a track bar is convexly provided on the refrigerator cover, and
wherein the refrigerator cover is slidably arranged on the refrigerator support seat in such a manner that the track bar is in the track groove.
